(19) United States
(12) Patent Application Publication
(10) Pub. No.: US 2006/0116962 A1
(43) Pub. Date: Jun. 1, 2006

(54) Information processing terminal, business information processing device, delivery information processing method and delivery information processing system

(76) Inventor: Masaki Wakabayashi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/271,807

(22) Filed: Nov. 14, 2005

(30) Foreign Application Priority Data
Nov. 29, 2004 (JP) 2004-343287

(51) Int. Cl. H04L 9/00

(52) U.S. Cl. 705/51

(57) ABSTRACT

This invention provides a delivery system which enables desired day and time of delivery and a relevant address and name to be notified to a delivery service operator while keeping the point of contact whose disclosure is not desired by the receiver of delivery. A business information processing device, using an identifier, accesses an information processing terminal storing delivery destination information regarding the address and name and the point of contact whose disclosure is not desired. The terminal, upon receiving a request for disclosure or a notification, transfers the request to a transferee terminal and obtains the user's consent or any desired information. The terminal is relieved of the need to disclose the confidential point of contact arbitrarily by transmitting only delivery destination information and any desired information to a business information processing device.

### CLAIM OF PRIORITY

The present application claims priority from Japanese application serial no. JP 2004-343287, filed on Nov. 29, 2004, the content of which is hereby incorporated by reference into this application.

### BACKGROUND OF THE INVENTION

The present invention relates to a delivery service using network communication and a delivery information processing system for realizing such service.

There is available an option which, when the sender of a parcel requests a parcel delivery service operator to forward a consignment, allows the sender to designate the day and time of delivery. When this option is exercised, prior adjustment of the day and time of delivery is needed between the sender and the receiver in order for the receiver of the consignment to be able to receive without fail at the first attempt of the delivering personnel to deliver it. Failure to make this adjustment properly may oblige the delivering personnel to bring the consignment to the receiver's address more than once on account of the absence of the receiver or some other reason, and eventually the sender's designation of the day and time of delivery may lose its sense. As a result, the parcel delivery service operator would have to bear the additional cost of redelivery and the receiver, the trouble of asking the operator for redelivery.

To address this problem, an optional arrangement is available by which the parcel delivery service operator notifies the receiver of the planned day and time of delivery at the receiver's mobile information terminal or the like by e-mail or otherwise and confirm the receiver's presence at home (see Patent Reference 1: JP-A No. 2002-87546). There also is a known piece of literature according to which the mobile terminal is directly notified by e-mail (see Patent Reference 2: JP-A No. 2002-7527).

### SUMMARY OF THE INVENTION

In order to use any of the options referred to above, either the sender should know the e-mail address, the telephone number or the like at which the receiver can receive the communication by using his or her mobile information terminal or the like, or the receiver should register his or her available point of contact with the parcel delivery service operator's information processing terminal in advance. Since both parties have to disclose their respective private points of direct contact, persons who want to limit the disclosure of their personal information to the inevitable minimum cannot avail themselves of such an optional service. Also, on the part of the parcel delivery service operator, the trouble of maintaining and managing the private points of contact registered by customers, and should any of such personal information leaks out, the operator's creditability would inevitably be marred.

An object of the present invention, attempted in view of the problems noted above, is to provide a method by which the prospective receiver of a consignment can receive information on the consignment without registering or notifying his or her available point of direct contact to the information processing terminal of the sender or of the parcel delivery service operator, and the receiver can make the day and time of delivery of his or her preference known to the parcel delivery service operator.

Another object of the invention is to provide a method by which the trouble of chit inputting can be reduced by enabling the information processing terminal of the parcel delivery service operator to readily acquire delivery information needed for delivery, including the names and addresses of the sender and the receiver, and by which the leak of such information can be prevented.

In order to achieve the objects stated above, a network-utilizing delivery information processing system according to the invention includes an information processing terminal used by at least one of a sender and a receiver and a business information processing device used by a parcel delivery service operator.

The information processing terminal includes a memory unit for storing the terminal's own identification (ID) information and delivery information and a communication unit for communicating the information to the business information processing device and other information processing terminals. The ID information includes what can uniquely identify the information processing terminal, such as an IP address or an IP telephone number, which should essentially be disclosed. The delivery information, required for identifying the destination of delivery, such as the name and address of the user of the information processing terminal, while the transferee information includes information on the point of contact at which the user can be directly contacted. The transferee information is not specifically limited to the telephone numbers of communication partners for the mobile telephone but may be the IP addresses and port numbers of the destinations of communication. It is necessary information for receiving notifications from the information processing terminal.

The business information processing device is provided with a communication unit for communicating with the information processing terminal. In this system, first, at least one of the sender and the receiver, using the delivery information registering unit, registers, in advance, delivery information, ID information and transferee information into the memory unit of his or her own information processing terminal. The sender may notify the ID information instead of notifying the delivery information or the transferee information to the business information processing device. The communication unit of the business information processing device, using the ID information, connects to a uniquely identifiable information processing terminal, and transmits a request for disclosure of the delivery information. The communication unit of the information processing terminal, upon receiving the request for disclosure, checks whether or not the source of the request for disclosure is reliable.

If information to the effect that a transfer is to be made to the transferee information processing terminal is set in the memory unit of the information processing terminal, the request for disclosure will be transferred to the transferee information processing terminal. The communication unit of the transferee information processing terminal receives and outputs the request for disclosure. The user of the transferee information processing terminal, when the response to the request for disclosure is inputted, transmits it to the communication unit of the information processing terminal. If the response received from the transferee information processing terminal received by the communication unit of the information processing terminal or a transferee information setting unit sets the transfer to be unnecessary and the information processing terminal has confirmed the source of the request for disclosure to be reliable, delivery information stored in the memory unit of the information processing terminal will be read out, and the delivery information and any information designated by the bearer designates are transferred to the business information processing device without having to notify any transferee information whose disclosure is undesirable to the business information processing device. Hereupon, the business information processing device can use these pieces of information for entry into delivery chits.

Or if the response received by the communication unit of the information processing terminal from the transferee information processing terminal is a refusal to the request for disclosure, the response and any information designated by the user will be transferred to the business information processing device without having to notify the transferee information whose disclosure is not desired to the business information processing device.

The configuration described above makes it unnecessary for any transferee to disclose transferee information whose disclosure to the business information processing device is not desired, and it is thereby made possible to realize prevention of avoidable leaks of any personal information such as transferee information on the point of contact at which direct contact is possible. Also, since the ID information used is what essentially is to be disclosed and even the delivery information which is to be kept confidential is notified to the business information processing device only after it has gone through processes of requesting disclosure and of authentication, avoidable leaks of any personal information such as delivery information can be prevented. Furthermore, as delivery information stored in the memory unit of the information processing terminal from which the communication unit of the business information processing device receives communication can be used, the trouble of manually writing delivery chits can be saved.

According to the present invention, a delivery system which prevents leaks of personal information whose disclosure is undesirable from be realized. Or, a delivery system which can save the trouble of manually writing delivery chits can be realized.

### BRIEF DESCRIPTION OF THE DRAWINGS

FIG. 1 is a functional block diagram of a network-utilizing delivery system.

FIG. 2 is a diagram of sequence of execution until the acquisition of the sender's delivery information.

FIG. 3 is a diagram of sequence of execution until the acquisition of the receiver's delivery information.

### DETAILED DESCRIPTION OF THE PREFERRED EMBODIMENT

A preferred embodiment of the present invention will be described below with reference to the accompanying drawings.

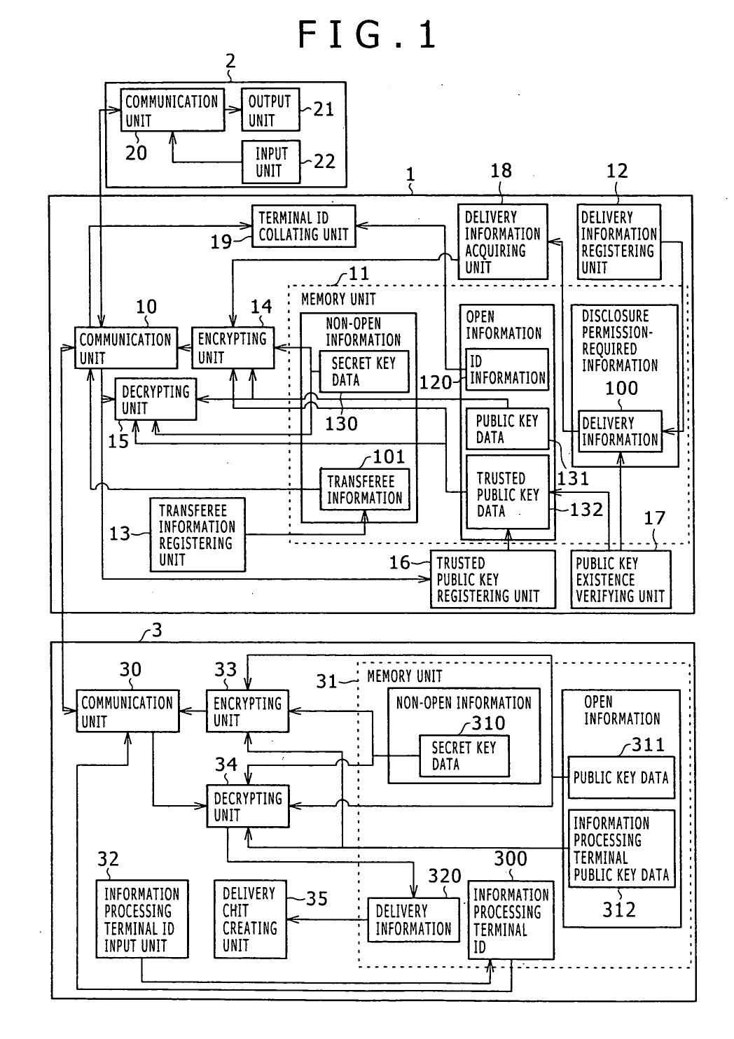

FIG. 1 is a functional block diagram showing the functional configuration of a network-utilizing delivery system, which is a preferred embodiment of the invention. It is mainly composed of an information processing terminal 1, a transferee information processing terminal 2 and a business information processing device 3.

The information processing terminal 1 is used by at least one of the sender and the receiver using the delivery service. Hereinafter, when distinction should be made between the two using parties, a sign S is added to the reference sign to denote the sender and R to denote the receiver, such as the sender information processing terminal 1S or the receiver information processing terminal 1R. For the transferee information processing terminal 2, too, when distinction should be made between the two using parties, a sign S is added to the reference sign to denote the sender and R to denote the receiver. The business information processing device 3 is intended for processing information regarding delivery operations.

The communication unit 10 of the sender information processing terminal 1S can communicate with the sender's transferee information processing terminal 1R and the business information processing device 3.

The memory unit 11S of the sender information processing terminal 1S can store delivery information 100S needed for delivery including the sender's address and name, transferee information 101S indicating the point of contact at which the sender can respond, ID information 120S of the information processing terminal used by the sender, the sender's secret key data 130S, the sender's public key data 131S and the trusted public key data 132S of another party whom the sender trusts.

The memory unit 11R of the receiver information processing terminal 1R, like 11S, can store delivery information 100R needed for delivery including the receiver's address and name, transfer information 101R indicating the point of contact at which the receiver can directly respond, identification (ID) information 120R of the information processing terminal used by the receiver, the receiver's secret key data 130R, the receiver's public key data 131R, and the trusted public key data 132R of another party whom the receiver trusts.

A delivery information registering unit 12 can register in the memory unit 11 information needed for delivery including the address and name of the user of the information processing terminal.

A transferee information registering unit 13 registers in the memory unit 11 transferee information 101 as the point of contact at which the user of the information processing terminal can directly respond, such as the user's mobile telephone number or e-mail address. This transferee information, whose coverage is not specifically limited to parties communicating with the mobile telephone, is necessary for receiving any notification from the information processing terminal, including for instance the IP address and the port number of the computer of the destination of notification. The information is only required to uniquely identify the information processing terminal.

An encrypting unit 14 encrypts the contents of communication to be transmitted by the communication unit 10 by using the secret key data 130 and the public key data 131 to make it difficult for any third party to read the contents of communication.

A decrypting unit 15 converts the contents of communication received by the communication unit 10 into a readable form by using the secret key data 130 and the trusted public key data 132.

A trusted public key registering unit 16 can register, in the memory unit 11, parties whom the user of the information processing terminal 1 trusts, such as the public key 132 of the business information processing device 3.

A public key existence verifying unit 17 performs the role of handing over the trusted public key data 132 stored in the memory unit 11 to the decrypting unit 15. If the received contents can thereby decrypted correctly, the requesting party can be identified and what is requested will be known.

A delivery information acquiring unit 18 performs the role of reading out the delivery information 100 stored in the memory unit 11 and handing it over to the encrypting unit 14. Since this enables the delivery information 100 to be transmitted to the business information processing device 3 in an encrypted form, the contents of communication cannot be readily read by any third party. A terminal ID collating unit 19 has a function to judge whether or not ID information transmitted from the communication unit 30 of the business information processing device 3 and received by the communication unit 10 of the information processing terminal 1 is identical with the ID information 120 stored in the memory unit 11. If the two pieces of ID information are found identical, the unit will judge that it is addressed to the information processing terminal continues to process subsequently received data.

A communication unit 20 can communicate with the communication unit 10 of the information processing terminal 1. An output unit 21 outputs the contents received by the communication unit 20 and waits for a response from the user. An input unit 22 can input the response to the output and any desired information, and hands over the contents thereof to the communication unit 20. A communication unit 30 can communicate with the communication unit 10 of the information processing terminal 1. A memory unit 31 can store secret key data 310 of the information processing terminal 3, public key 311 of the information processing terminal 3, public key data 312 of the information processing terminal, and delivery information 320. An information processing terminal identification (ID) input unit 32 can input an information processing terminal identifier (ID) 300 for identifying the information processing terminal to communicate with, and stores this information processing terminal ID 300 into the memory unit 31. After that, the information processing terminal ID is handed over to the communication unit 30 and, if the information processing terminal 1 to which the information processing terminal ID is allocated is discovered, will start direct communication with the information processing terminal 1.

An encrypting unit 33 encrypts the contents of communication to be transmitted by the communication unit 30 with the secret key data 310 and the public key data 312 to make it difficult for any third party to read the contents of communication. A decrypting unit 34 decrypts the contents of communication received by the communication unit 30 with the secret key data 310 and the public key data 312 of the information processing terminal, and thereby converts the contents of communication into a readable form. A delivery chit creating unit 35 can create a delivery chit by using the delivery information 320 stored in the memory unit 31.

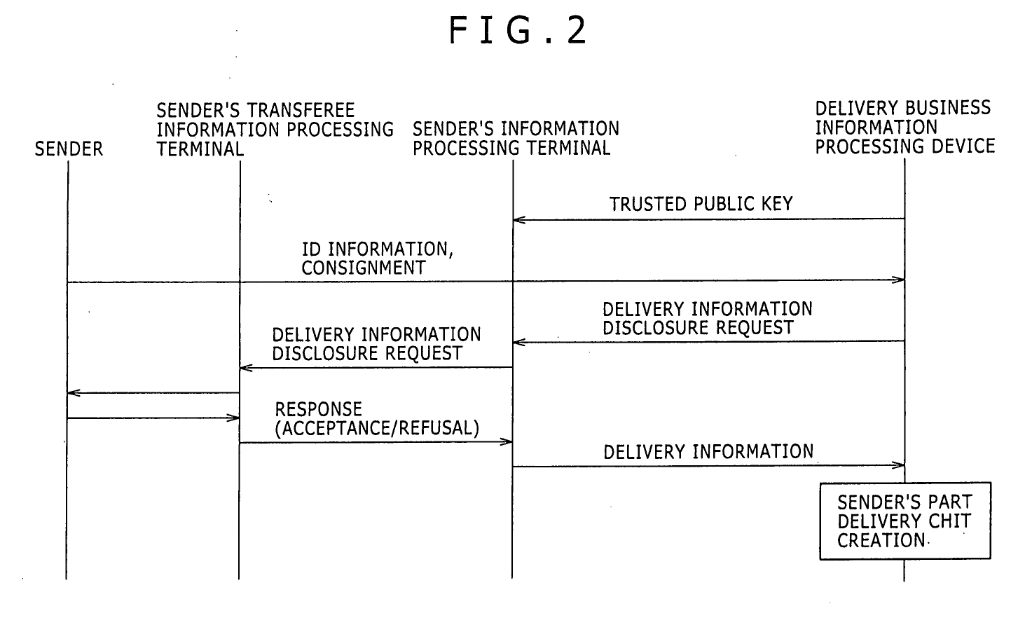

FIG. 2 shows an example of diagram of sequence of execution until the acquisition of the sender's delivery information. This example illustrates the flow of notification by the sender only of delivery information required for delivery without having to notify the business information processing device of the sender's own transferee information.

First, delivery information 100S, transferee information 101S and identification (ID) information 120S are stored in advance in the memory unit 11S of the sender information processing terminal 1S. When communication with outside is to be encrypted, the secret key data 136S and the public key data 131S are created in advance. Further, the sender information processing terminal 1S acquires in advance the delivery service operator's public key 132 of which the delivery information 100S can be disclosed. This process regarding encryption is not indispensable.

The sender inputs the identification (ID) information 300 of the sender information processing terminal 1S to the information processing terminal ID input unit 32 of the business information processing device 3. The business information processing device 3 discovers the information processing terminal 1S on the basis of the ID information 300, and transmits a request for disclosure of the ID information 120S and the sender's delivery information 100. Having received the ID information 300, the communication unit 10S hands over the ID information 300 to a terminal ID collating unit 19S to confirm that the party requested for disclosure is the information processing terminal 1S, and checks whether or not it is identical with the ID information 120S stored in the memory unit 11S. If they are not found identical, either the ID information 300 and the request for disclosure are discarded or transferred to another destination. Or if they are found identical, it will be judged that the request is addressed to the sender information processing terminal and the processing will be continued.

If the transferee information 101S is registered in the memory unit 11S, the request for disclosure will be transferred to the sender transferee information processing terminal 2. The output unit 21 of the sender transferee information processing terminal 2 outputs to the sender a request for disclosure of the delivery information 100S, and the input unit 22 hands over a response to it to the communication unit 20 to have it transmitted the sender information processing terminal 1S. When the response is received by the communication unit 10 of the sender information processing terminal 1, if the response is a refusal, the delivery information 100S will not be transmitted to the business information processing device 3, and the response and any desired information will be transferred to the business information processing device 3. Or if the response is a consent, the delivery information 100S and any desired information will be handed over to the encrypting unit 14. In the encrypting unit 14, the pieces of information are encrypted by using at least one of the secret key data 130S and the trusted public key data 132, and transferred to the business information processing terminal 3 via the communication unit 10.

When the communication unit 30 of the business information processing device 3 hands over the received contents to the decrypting unit 34, the decrypting unit 34 decrypts the contents by using either the secret key data 310S or the public key data 312 of the information processing terminal and thereby acquires the delivery information 100S. The delivery information 100S thereby acquired is stored into the memory unit 31 as the delivery information 320. After that, the delivery chit creating unit creates a chit for delivery by using the sender's delivery information 320.

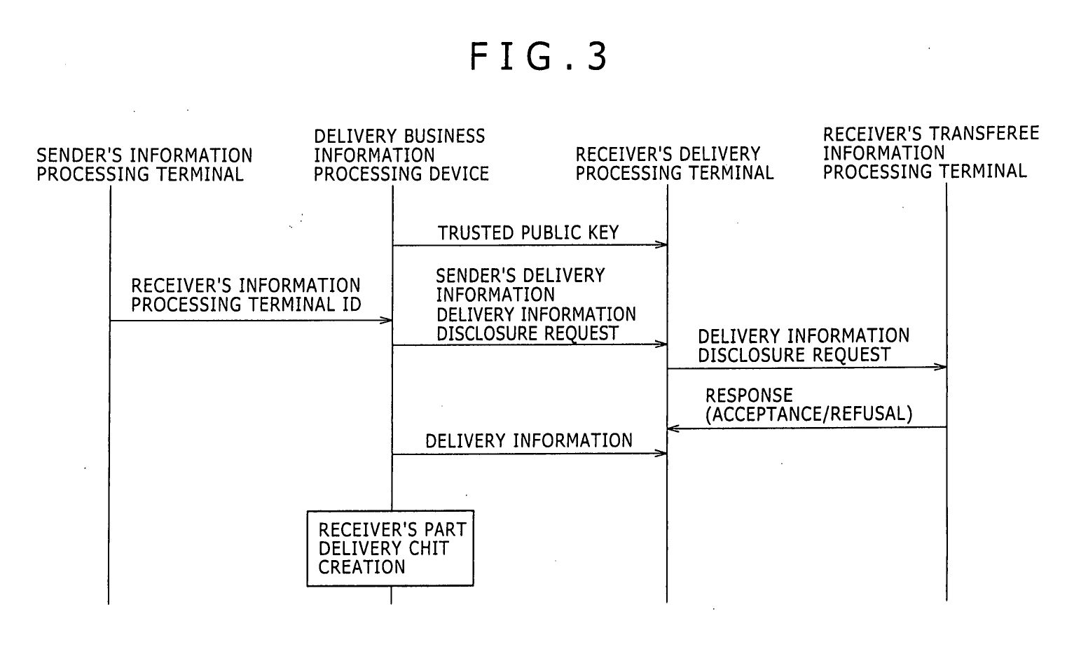

FIG. 3 shows an example of diagram of sequence of execution until the acquisition of the receiver's delivery information.

This example illustrates the flow following the sequence shown in FIG. 2 until the receiver's delivery information is acquired and a delivery chit is created without having to notify the business information processing device of the receiver's transferee information.

First, the delivery information 100R, transferee information 101R and ID information 120R are stored into the memory unit 11R of the sender information processing terminal 1R in advance. When communication with outside is to be encrypted, the secret key data 130R and the public key data 131R are created in advance. Further, the sender information processing terminal 1R acquires in advance the delivery service operator's public key 132 of which the delivery information 100R can be disclosed.

The sender inputs the ID information 300 of the receiver information processing terminal 1R to the information processing terminal ID input unit 32 of the business information processing device 3. The business information processing device 3 discovers the information processing terminal 1R on the basis of the ID information 300, and transmits a request for disclosure of the ID information 120R and the sender's delivery information 100R. Hereupon, the sender's delivery information can be transmitted at the same time.

Having received the ID information 300, the communication unit 10R hands over the ID information 300 to a terminal ID collating unit 19R to confirm that the party requested for disclosure is the information processing terminal 1R, and checks whether or not it is identical with the ID information 120R stored in the memory unit 11R. If they are not found identical, either the ID information 300 and the request for disclosure are discarded or transferred to another information processing terminal. Or if they are found identical, it will be judged that the request is addressed to the receiver information processing terminal and the processing will be continued.

If the transferee information 101R is transferred in the memory unit 11R, the request for disclosure will be transferred to the sender transferee information processing terminal 2R. The output unit 21R of the sender transferee information processing terminal 2R outputs to the sender a request for disclosure of the delivery information 100R and the sender's delivery information, and the input unit 22R hands over a response to it to the communication unit 20R to have it transmitted to the sender information processing terminal 1R. The transmission of the sender's delivery information, though not indispensable, provides the following advantages. Namely, by transmitting the sender's delivery information as well, not only verification to the business information processing device 3 but also the confirmation the sender himself or herself can be accomplished to make it possible to refuse to accept a consignment sent by a dubious sender.

When the response is received by the communication unit 10R of the sender information processing terminal 1R, if the response is a refusal, the delivery information 100R will not be transmitted to the business information processing device 3, and the response and any desired information will be transferred to the business information processing device 3. Or if the response is a consent, the delivery information 100R and any desired information will be handed over to the encrypting unit 14, in which the pieces of information are encrypted by using at least one of the secret key data 130R and the trusted public key data 132, and transferred to the business information processing terminal 3 via the communication unit 10. The desired information mentioned above may include information the receiver desires to include, such as the preferred day and time of delivery and the place of delivery.

When the communication unit 30 of the business information processing device 3 hands over the received contents to the decrypting unit 34, the decrypting unit 34 decrypts the contents by using at least one of the secret key data 310R and the public key data 312 of the information processing terminal and thereby acquires the delivery information 100R. The delivery information 100R thereby acquired is stored into the memory unit 31 as the delivery information 320. After that, the delivery chit creating unit creates a chit for delivery by using the sender's delivery information 320.

Although the object of delivery is supposed to be a parcel in the embodiment described above, what is to be delivered need not be limited to a parcel. For instance, if the object of delivery is supposed to be data such as what the information processing terminal handles, and the parcel delivery service operator is instead an operator of service of delivery of data to the information processing terminal 1, the invention can be applied to a data delivery system for use in a computer network with similar advantages to those ascribed in the foregoing description to the present invention.

What is claimed is:

1. An information processing terminal comprising a communication unit for communicating with other devices and a memory unit for holding information, provided with:
a delivery destination information registering unit for storing delivery destination information into the memory unit, and
a transferee information setting unit for registering transferee information for use in transferring, from a requestor of disclosure, a request for disclosure of delivery destination information held in the memory unit, wherein:
when the request for disclosing delivery destination information is received and the transferee information is already set by the transferee information setting unit, the communication unit transfers the request for disclosing the delivery destination information to a transferee information processing terminal on the basis of undisclosed transferee information registered in the memory unit by the transferee information setting unit.

2. The information processing terminal according to claim 1, wherein the communication unit controls the choice of whether or not to transmit delivery destination information held in the memory unit to a source of the request for disclosure in accordance with contents of a response from the transferee information processing terminal to which the request for disclosure has been transferred.

3. The information processing terminal according to claim 1, wherein the information processing terminal is provided with a reliability assessing unit which judges whether or not the source of a request for disclosure of delivery destination information held in the memory unit is reliable; when a request for disclosure of delivery destination information has been received and set by the transferee information setting unit to be unnecessary to transfer, and the reliability assessing unit has judged the source of the request for disclosure to be reliable, delivery destination information registered by the delivery destination information registering unit is read out of the memory unit, and the communication unit transmits the delivery destination information to the source of the request for disclosure.

4. The information processing terminal according to claim 1, further provided with a terminal ID collating unit, wherein the communication unit receives identification (ID) information of the information processing terminal of the source of the request for disclosure transmitted by the source of the request for disclosure of the delivery destination information, and the terminal ID collating unit collates with the received ID information and the ID information stored in the memory unit, and controls the choice of whether or not to transfer the delivery destination information to the transferee information processing terminal on the basis of a result of the collation.

5. The information processing terminal according to claim 1, wherein the delivery destination information to be stored in the memory unit is delivery destination information regarding one of the sender and the receiver of the consignment.

6. The information processing terminal according to claim 1, further provided with at least one of an encrypting unit and a decrypting unit, wherein the encrypting unit encrypts contents to be communicated by using key data stored in the memory unit or key data received by the communication unit, and the decrypting unit decrypts the contents of communication by using the key data.

7. The information processing terminal according to claim 6, wherein the key data is at least one of a secret key and a public key regarding the information processing terminal.

8. The information processing terminal according to claim 1, further provided with a trusted key registering unit and a key existence verifying unit, wherein the trusted key registering unit, when the source of the request for disclosure of delivery destination information is reliable, registers, into the memory unit, key data for use in decryption of contents transmitted by the source of the request for disclosure; and the key existence verifying unit checks whether or not the key data acquired from the source of the request for disclosure and the key data registered in the memory unit registered by the trusted key registering unit are identical and, instead of transferring the request to the transferee information processing terminal on the basis of a result of check by the key existence verifying unit, transmits delivery destination information read out of the memory unit to the source of the request for disclosure.

9. The information processing terminal according to claim 8, wherein the key data registered by the trusted key registering unit is a public key.

10. A business information processing device comprising a communication unit for communicating with other devices and a memory unit for holding information,
further provided with information processing terminal ID input unit, wherein the information processing terminal ID input unit inputs an identifier (ID) of an information processing terminal with which the communication unit communicates; the communication unit, using the inputted ID information, communicates with the information processing terminal, and transmits a request for disclosure of delivery destination information which the information processing terminal has; transferee information on the request for disclosure is set at the information processing terminal; the request for disclosure is transferred to the transferee information processing terminal; when a response of consent to the request for disclosure returns to the information processing terminal, the delivery destination information is received from the information processing terminal, and the received delivery destination information is stored into the memory unit.

11. The business information processing device according to claim 10, further provided with at least one of an encrypting unit and a decrypting unit, wherein the encrypting unit encrypts contents to be communicated by using key data stored in the memory unit or key data received by the communication unit, and the decrypting unit de crypts the contents of communication by using the key data.

12. The business information processing device according to claim 11, wherein the key data is at least one of a secret key and a public key regarding the business information processing terminal.

13. The business information processing device according to claim 10, further provided with a delivery chit creating unit, wherein the delivery chit creating unit creates delivery chits by using the delivery destination information.

14. A delivery information processing system comprising an information processing terminal provided with a communication unit for communicating with other devices and a memory unit for holding information, a transferee information processing terminal for receiving transfer of information from the information processing terminal, and a business information processing terminal for communicating with the information processing terminal, wherein:
the information processing terminal is provided with a delivery destination information registering unit for storing delivery destination information into the memory unit, and a transferee information setting unit for registering transferee information for use in transferring, to the transferee information processing terminal, a request for disclosure of delivery destination information held in the memory unit from the business information processing terminal, and
the information processing terminal receives the request from the business information processing device for disclosing delivery destination information; when the transferee information is set by the transferee information setting unit, the communication unit transfers the request for disclosing the delivery destination information to the transferee information processing terminal on the basis of undisclosed transferee information registered in the memory unit, and controls a choice of whether or not to transmit the delivery destination information held in the memory unit to the business information processing device on the basis of contents of a response from the transferee information processing terminal to which the request for disclosure has been transferred.

15. A delivery information processing method for an information processing terminal which communicates with other devices and is provided with a memory unit for holding information, comprising:
a step of storing delivery destination information into the memory unit,
a step of receiving a request for disclosure of delivery destination information from a source of a request for disclosure, the source requesting disclosure of the delivery destination information held in the memory unit,
a step of registering, into the memory unit, transferee information for transferring the request for disclosure,
a step of receiving the request for disclosure of the delivery destination information and, when the transferee information is already set, transferring the request for disclosure of the delivery destination information to a transferee information processing terminal on the basis of undisclosed transferee information registered in the memory unit, and
a step of controlling a choice of whether or not to transmit delivery destination information held in the memory unit to the source of the request for disclosure on the basis of contents of the response from the transferee information processing terminal to which request for disclosure has been transferred.
